(19) United States
(12) Patent Application Publication
(10) Pub. No.: US 2015/0339704 A1
(43) Pub. Date: Nov. 26, 2015

(54) VALUING ONLINE CONTENT SERVED TO AN ONLINE PUBLISHER

(71) Applicant: Google Inc., Mountain View, CA (US)

(72) Inventors: Zhenyu Liu, San Jose, CA (US); Ping Wu, Saratoga, CA (US)

(73) Assignee: Google Inc., Mountain View, CA (US)

(21) Appl. No.: 13/689,438

(22) Filed: Nov. 29, 2012

(51) Int. Cl. G06Q 30/02

(52) U.S. Cl. CPC G06Q 30/0247

(57) ABSTRACT

Methods and systems for valuing an item of online content served to an online publisher, such as an advertisement, are provided. The methods and systems described herein enable an advertiser to determine the relative value of an advertisement presented to one consumer as compared to the value of the same advertisement presented to another consumer. The expected total lifetime revenue generated as a result of presentation of a specific advertisement to a specific consumer is determined, to enable an advertiser to determine how aggressively to bid for placement of the advertisement with a publisher.

### BACKGROUND

The present disclosure relates to online content, and, more particularly, to valuing online content for display to a user, wherein the valuing is based on an expected lifetime revenue of the user.

Publishers of online content frequently permit the placement of other online content on the publisher's web pages, in exchange for payment. Frequently, this other online content is served to the publishers for placement on the publishers' web pages in a coordinated manner in response to an online user's selection of a publisher's web page. An online content serving system may use certain criteria, such as information relating to a user computer device to identify, select, and serve online content to the publisher.

Publishers of online content typically require entities that want to display their online content on the publishers' web pages to bid for the opportunity to have their online content placed on the publishers' webpages. The bids take one of several different possible forms, relating to the basis on which a publisher is paid. In one form, a publisher is paid on a cost-per-impression (CPM) basis. Specifically, a publisher is paid a fixed amount for each instance that certain online content is shown to an online user. In another form, a publisher is paid on a cost-per-click (CPC) basis. Specifically, a publisher is paid a fixed amount for each instance that an online user selects or “clicks” on the online content. In still another form, a publisher is paid on a performance-based cost-per-action (“CPA”) basis. Specifically, the publisher is paid a fixed amount, for each instance that an online user takes one of a number of predefined qualifying actions after “clicking” on the online content.

### BRIEF DESCRIPTION

In an aspect, a computer-implemented method for valuing an advertisement served to an online publisher is provided. The method is implemented using a computer device coupled to a memory device. The method includes storing, within the memory device, past revenue data associated with presenting a plurality of types of advertisements to a selected user. The method includes determining, using the computer device, a total lifetime revenue amount associated with presenting each advertisement type of the plurality of advertisement types to the selected user. The method includes storing, within the memory device, a lifetime profit threshold received from an advertiser associated with serving one of the plurality of advertisement types associated with the advertiser for presentation to the selected user. The method includes determining a price to be charged to the advertiser for serving a first advertisement type of the plurality of advertisement types to the selected user, the price being a function of the determined total lifetime revenue amount and the lifetime profit threshold for the first advertisement type.

In another aspect, computer-readable storage media having computer-executable instructions embodied thereon are provided. When executed by at least one processor, the computer-executable instructions cause the processor to store past revenue data associated with presenting a plurality of types of advertisements to a selected user. The computer-executable instructions further cause the processor to determine a total lifetime revenue amount associated with presenting each advertisement type of the plurality of advertisement types to the selected user. The computer-executable instructions further cause the processor to store a lifetime profit threshold received from an advertiser associated with serving one of the plurality of advertisement types associated with the advertiser for presentation to the selected user. The computer-executable instructions further cause the processor to determine a price to be charged to the advertiser for serving a first advertisement type of the plurality of advertisement types to the selected user, the price being a function of the determined total lifetime revenue amount and the lifetime profit threshold for the first advertisement type.

In another aspect, a computer system is provided. The computer system includes a processor and a computer-readable storage device having encoded thereon computer-readable instructions that are executable by the processor. The computer-readable instructions cause the processor to store past revenue data associated with presenting a plurality of types of advertisements to a selected user. The computer-readable instructions further cause the processor to determine a total lifetime revenue amount associated with presenting each advertisement type of the plurality of advertisement types to the selected user. The computer-readable instructions further cause the processor to store a lifetime profit threshold received from an advertiser associated with serving one of the plurality of advertisement types associated with the advertiser for presentation to the selected user. The computer-readable instructions further cause the processor to determine a price to be charged to the advertiser for serving a first advertisement type of the plurality of advertisement types to the selected user, the price being a function of the determined total lifetime revenue amount and the lifetime profit threshold for the first advertisement type.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a block diagram depicting an example advertising environment.

FIG. 2 is a diagram of an example advertising serving system shown in FIG. 1.

FIG. 3 is a flowchart of an example method implemented using the advertising server system of FIGS. 1 and 2 for valuing an advertisement served to an online consumer.

FIG. 4 is a diagram of an example computing systems that may be used in the environment shown in FIG. 1 in accordance with one embodiment of the present disclosure.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of various implementations refers to the accompanying drawings. The same reference numbers in different drawings may identify the same or similar elements. Also, the following detailed description of various implementations does not limit the disclosure.

As used herein, an element or step recited in the singular and proceeded with the word “a” or “an” should be understood as not excluding plural elements or steps, unless such exclusion is explicitly recited. Furthermore, references to “one embodiment” of the subject matter described herein are not intended to be interpreted as excluding the existence of additional embodiments that also incorporate the recited features.

The subject matter described herein relates generally to online content and/or online advertising. Specifically, the methods and systems herein enable an advertiser to value an advertisement to be presented to a publisher, in order to determine an appropriate amount to bid for placement of the advertisement with the publisher. The methods and systems described herein enable an advertiser to take into account the past revenue generated by a consumer to whom the same or similar advertisements have been presented. The methods and systems described herein also enable an advertiser to take into account potential future revenue that may be generated by a consumer to whom the advertisement will be presented. The methods and systems described herein enable an advertiser to use the past and estimated future revenue information associated with a specific consumer to adjust the amount the advertiser will bid for placement of the advertisement with the publisher.

The methods and systems described herein may be implemented using computer programming or engineering techniques including computer software, firmware, hardware or any combination or subset thereof, wherein the technical effects may be achieved by performing at least one of the following steps: a) storing, within the memory device, past revenue data associated with presenting a plurality of types of advertisements to a selected user; (b) determining, using the computer device, a total lifetime revenue amount associated with presenting each advertisement type of the plurality of advertisement types to the selected user; (c) storing, within the memory device, a lifetime profit threshold received from an advertiser associated with serving one of the plurality of advertisement types associated with the advertiser for presentation to the selected user; (d) determining, using a computer device, a price to be charged to the advertiser for serving a first advertisement type of the plurality of advertisement types to the selected user, the price being a function of the determined total lifetime revenue amount and the lifetime profit threshold for the first advertisement type; (e) determining, using the computer device, a past revenue total amount associated with serving the first advertisement type of the plurality of advertisement types to the selected user; (f) predicting, using the computer device, a future revenue total amount associated with potential future service of the first advertisement type of the plurality of advertisement types to the selected user; (g) determining, using the computer device, a plurality of auction scores associated with the service of each of the plurality of advertisement types to the selected user, wherein the magnitude of an auction score associated with an advertisement type is proportional to a total lifetime revenue amount associated with the advertisement type; (h) selecting, using the computer device, the advertisement type having the highest determined auction score; (i) determining, using the computer device, the price charged to the advertiser as the difference between the total lifetime revenue amount associated with service of the first advertisement type to the selected user, and the lifetime profit threshold, wherein the lifetime profit threshold is an advertiser-specified lifetime gross profit associated with service of the first advertisement type to the selected user; (j) determining, using the computer device, the price charged to the advertiser as the product of the total lifetime revenue amount associated with service of the first advertisement type to the selected user, and the lifetime profit threshold, wherein the lifetime profit threshold is an adjustment factor based on an advertiser-specified percentage of gross revenue associated with the service of the first advertisement type to the selected user; and (k) determining, using the computer device, an auction score as a function of at least one of: a determined price associated with the first advertisement type; a determined probability of action by the selected user following selection by the selected user of the first advertisement type for viewing; a determined probability of selection by the selected user of the first advertisement type for viewing following an impression of the first advertisement type; and a predicted auction discount.

The following description refers to the accompanying drawings, in which, in the absence of a contrary representation, the same numbers in different drawings represent similar elements.

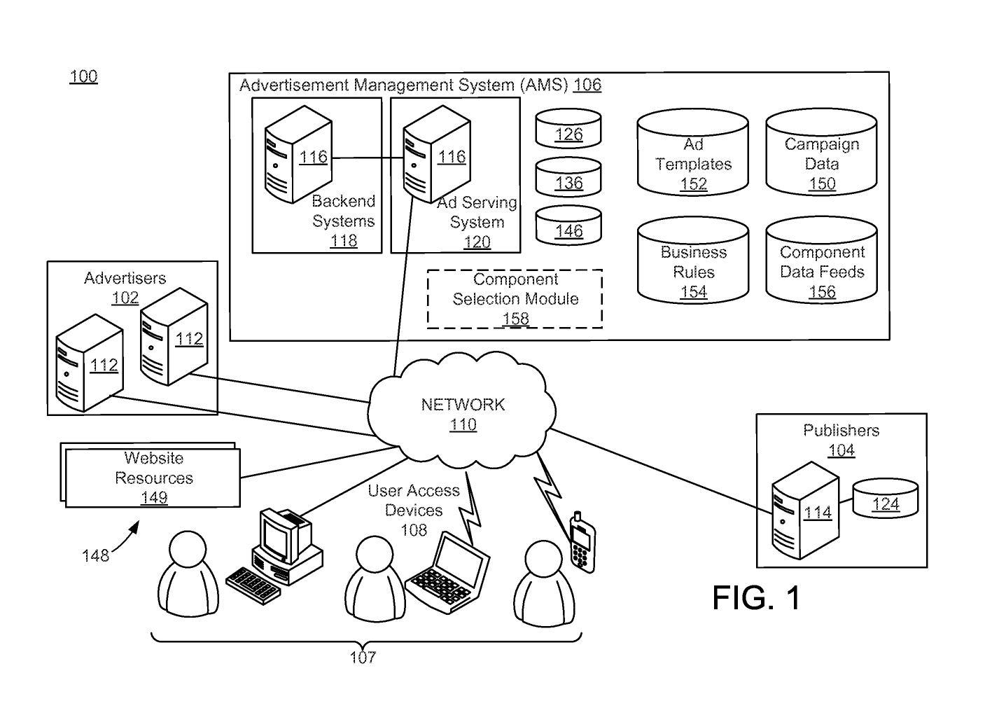

With reference to FIG. 1, an example advertising environment 100 may include one or more advertisers 102, one or more publishers 104, an advertisement management system (AMS) 106, and one or more user access devices 108, employed by users 107, which may be coupled to a network 110. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to or include sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is receivable and viewable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, maintain, measure, and/or analyze ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. “Publishers,” in particular, includes authors of online content, wherein authors may be individual persons, or, in the case of works made for hire, the proprietor(s) who hired the individual(s) responsible for creating the online content. The term “content” refers to various types of web-based and/or otherwise presented information, such as articles, discussion threads, reports, analyses, financial statements, music, video, graphics, search results, web page listings, information feeds (e.g., RSS feeds), television broadcasts, radio broadcasts, printed publications, etc.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include television broadcasters, radio broadcasters, satellite broadcasters, and other content providers. One or more of the publishers 104 may represent a content network that is associated with the AMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with ads that are related or relevant to the retrieved content for display to users. As discussed further below, these relevant ads may be provided from the AMS 106 and be combined with content for display to users. In some examples, the publishers 104 may retrieve content for display on a particular user access device 108 and then forward the content to the user access device 108 along with code that causes one or more ads from the AMS 106 to be displayed to the user. In other examples, the publishers 104 may retrieve content, retrieve one or more relevant ads (e.g., from the AMS 106 or the advertisers 102), and then integrate the ads and the article to form a content page for display to the user.

As noted above, one or more of the publishers 104 may represent a content network. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 manages ads and provides various services to the advertisers 102, the publishers 104, and the user access devices 108. The AMS 106 may store ads in ad repository 136, and conversion data regarding actions in repository 126, and facilitate the distribution or selective provision and recommendation of ads through the environment 100 to the user access devices 108. In some configurations, the AMS 106 may include or access functionality associated with an advertising serving system.

The AMS 106 may include one or more data processing systems 116, such as servers or embedded systems, coupled to the network 110. It can also include one or more processes, such as server processes. In some examples, the AMS 106 may include an ad serving system 120 and one or more backend processing systems 118. The ad serving system 120 may include one or more data processing systems 116 and may perform functionality associated with delivering ads to publishers or user access devices. The backend processing systems 118 may include one or more data processing systems 116 may perform functionality associated with identifying relevant ads to deliver, processing various rules, performing filtering processes, generating reports, maintaining accounts and usage information, and other backend system processing. The AMS 106 can use the backend processing systems 118 and the ad serving system 120 to selectively recommend and provide relevant ads from the advertisers 102 through the publishers 104 to the user access devices 108.

The AMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The AMS 106 may include one or more interface or frontend modules for providing the various features to advertisers, publishers, and user access devices. For example, the AMS 106 may provide one or more publisher front-end interfaces (PFEs) for allowing publishers to interact with the AMS 106. The AMS 106 may also provide one or more advertiser front-end interfaces (AFEs) for allowing advertisers to interact with the AMS 106. In some examples, the front-end interfaces may be configured as web applications that provide users with network access to features available in the AMS 106.

The AMS 106 provides various advertising management features to the advertisers 102. The AMS 106 advertising features may allow users to set up user accounts, set account preferences, create ads, select keywords for ads, create campaigns or initiatives for multiple products or businesses, view reports associated with accounts, analyze costs and return on investment, selectively identify consumers in different regions, selectively recommend and provide ads to particular publishers, analyze financial information, analyze ad performance, estimate ad traffic, access keyword tools, add graphics and animations to ads, etc.

The AMS 106 may allow the advertisers 102 to create ads and input keywords for which those ads will appear. In some examples, the AMS 106 may provide ads to user access devices or publishers when keywords associated with those ads are included in a user request or requested content. The AMS 106 may also allow the advertisers 102 to set bids for ads. A bid may represent the maximum amount an advertiser is willing to pay for each ad impression, user click-through of an ad or other interaction with an ad. A click-through can include any action a user takes to select an ad. The advertisers 102 may also choose a currency and monthly budget.

The AMS 106 may also allow the advertisers 102 to view information about ad impressions, which may be maintained by the AMS 106. The AMS 106 may be configured to determine and maintain the number of ad impressions relative to a particular website or keyword. The AMS 106 may also determine and maintain the number of click-throughs for an ad as well as the ratio of click-throughs to impressions.

The AMS 106 may also allow the advertisers 102 to select and/or create conversion types for ads. A “conversion” may occur when a user consummates a transaction related to a given ad. A conversion could be defined to occur when a user clicks on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The AMS 106 may store conversion data and other information in a conversion data repository 136.

The AMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide various features to the publishers 104. The AMS 106 may deliver ads (associated with the advertisers 102) to the user access devices 108 when users access content from the publishers 104. The AMS 106 can be configured to deliver ads that are relevant to publisher sites, site content and publisher audiences.

In some examples, the AMS 106 may crawl content provided by the publishers 104 and deliver ads that are relevant to publisher sites, site content and publisher audiences based on the crawled content. The AMS 106 may also selectively recommend and/or provide ads based on user device information and user device usage, such as particular search queries performed on a search engine website, etc. The AMS 106 may store user device information in a general database 146. In some examples, the AMS 106 can add search services (e.g., a search box) to a publisher site and deliver ads configured to provide appropriate and relevant content relative to search results generated by requests from visitors of the publisher site. A combination of these and other approaches can be used to deliver relevant ads.

The AMS 106 may allow the publishers 104 to search and select specific products and services as well as associated ads to be displayed with content provided by the publishers 104. For example, the publishers 104 may search through ads in the ad repository 136 and select certain ads for display with their content.

The AMS 106 may be configured to selectively recommend and provide ads created by the advertisers 102 to the user access devices 108 directly or through the publishers 104. The AMS 106 may selectively recommend and provide ads to a particular publisher 104 (as described in further detail herein) or a requesting user access device 108 when a user requests search results or loads content from the publisher 104.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

The user access devices 108 may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

Environment 100 further includes a website 148 including one or more resources 149 (e.g., text, images, multimedia content, and programming elements, such as scripts) associated with a domain name and hosted by one or more servers. Resources 149 can be relatively static (e.g., as in a publisher's webpage) or dynamically generated in response to user query (e.g., as in a search engine's result page).

User devices 108 can request resources 149 from a website 148. In turn, build data representing the resource 149 can be provided to the user access device 108 for presentation by the user access device 108. The build data representing the resource 149 can also include data specifying an ad slot in which advertisements can be presented.

When a resource 149 is requested by a user access device 108, the advertisement management system 106 receives a request for advertisements to be provided with the resource 149. The request for advertisements can include characteristics of the advertisement slots (e.g., size, web address of the resource, media type of the requested advertisement, etc.) that are defined for the requested resource or search results page, and can be provided to the advertisement management system 106.

Based on data included in the request for advertisements, the advertisement management system 106 can identify advertisements that are eligible to be provided in response to the request. For example, eligible advertisements can have characteristics matching the characteristics of available advertisement slots and have ad serving keywords that match the specified resource keywords or search queries.

Each advertiser 102 can create one or more advertising campaigns using various campaign parameters that are used to control distribution of the advertiser's advertisements. Each advertising campaign can include one or more ad groups that have modified campaign parameters that are specific to the ad group. Examples of campaign parameters can include ad serving keywords and corresponding bids, geographic or other factors used to facilitate ad serving, delivery period, content network, keyword match type, as well as other parameters corresponding to one or more advertisements. The campaign data can be stored in the campaign data store 150. The advertisement management system 106 can retrieve the information in the campaign data store 150 when preparing a response to an ad request.

Parameters related to an advertisement can include, for example, creative identifier, creative name, creative type, size, first line, web address of the landing page, display URL, media type, and so on. One of the creative types that an advertiser can specify for an ad is the dynamic ad type. The advertiser can provide an ad template as the creative, and the ad template can be selected (e.g., in the same manner as other types of creatives) to fulfill a received ad request for an available advertisement slot. When an ad template (or in other words, a dynamic ad creative) is selected to fulfill an ad request, a dynamic ad can be generated on-the-fly based on the ad template to fulfill the ad request.

The ad template can specify the general appearance, such as an invariable portion of the content and some aspects of the appearance and format of the dynamic ad. The invariable portion of the content and aspects of the dynamic ad remains the same across multiple dynamic ads generated using the same ad template.

In addition to specifying the invariable portion of the dynamic ad, the ad template also leaves some content or aspects of format and appearance of the dynamic ad unspecified. Instead, the ad template can specify one or more component slots which prescribe the requirements for data items (or components) that can be used to provide the unspecified content and aspects of format and appearance to complete the dynamic ad. Components having component characteristics (e.g., content, structural format, function, or other attributes) that satisfy the requirements of the component slots can be selected and inserted into the component slots to complete the dynamic ad. In some implementations, the ad templates can also specify how a selected component is applied to the component slot, such as the size, font, color, position, etc. of the selected component as the component appears in the dynamic ad.

The advertisers can specify multiple dynamic ad creatives or ad templates for use in the advertiser's ad campaigns. The ad templates can be stored along with other creatives (e.g., static image ads, video ads, text ads, etc.) in the campaign data store 150. In some implementations, the ad templates can be stored separately from the other types of creatives, for example, in an ad template data store 152. Individual ad templates can be retrieved by the advertisement management system 106 by the templates' creative IDs.

The advertisement management system 106 can have access to a large number of available components of various types, for example, through a component data feed store 156. The components can have varying content. The component data feed store 156 can be provided and updated by the advertiser from time to time. In some implementations, the component data feed store 156 can be linked to the advertiser's product catalogs or other business data stores, such that real-time data can be made available to the advertisement management system 106 without active intervention by the advertiser.

The advertisement management system 106 can select components from among the large number of components available in the component data feed store 156. The advertisement management system 106 can also apply the selected components to the component slots in a dynamic ad according to the specifications in an ad template selected from the ad template data store 152. Once the dynamic ad is constructed using the selected components, the dynamic ad can be provided by an advertisement management system to fulfill the received ad request. In some implementations, a component selection module 158 can be implemented to carry out actions related to component selection. The component selection module 158 can be part of the advertisement management system 106 or a standalone module in communication with the advertisement management system 106.

When the advertisement management system 106 selects components for the selected ad template in response to a received ad request, the advertisement management system 106 observes the business rules including the co-occurrence constraints specified for the selected ad template. The business rules can be specified by the advertiser through an interface provided by the advertisement management system 106. The business rules can be stored in the campaign data store along with other campaign data. Alternatively, the business rules can be stored in a business rule data store 154 apart from other types of campaign data. The business rules can be campaign specific, ad group specific, or ad template specific, for example.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes run on separate machines or a single process running on a single machine.

An advertiser can specify parameters of advertising campaigns and advertisements through an advertisement management system. The advertisement management system can receive ad requests from user devices and select ads according to information in the ad requests and the parameters of the advertising campaigns. The ads that are delivered can include dynamically generated ads as described above.

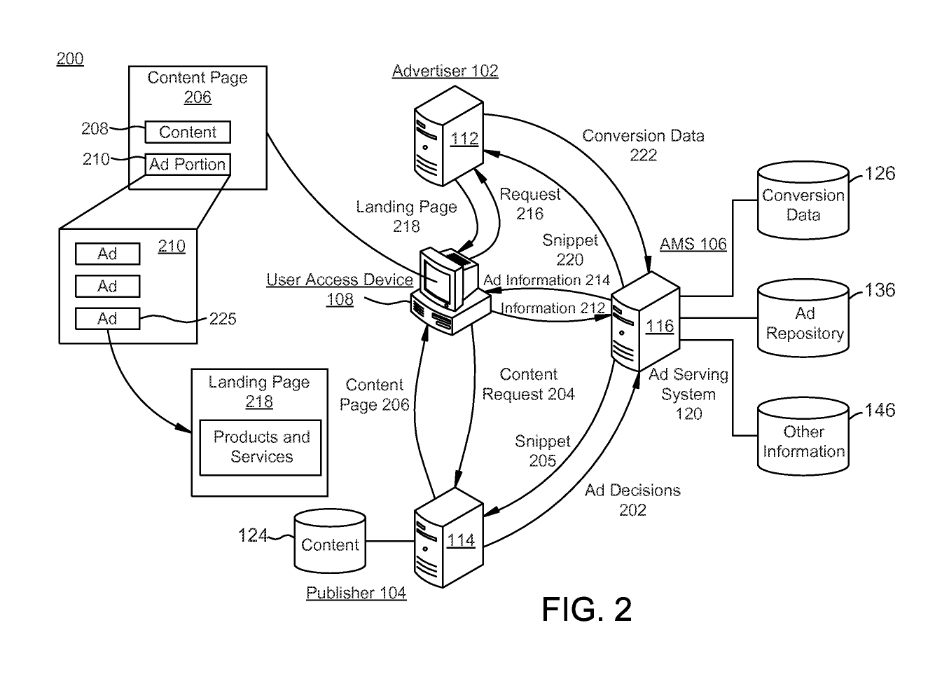

FIG. 2 illustrates an example data flow 200 within the environment 100. The data flow 200 is an example only and not intended to be restrictive. Other data flows may therefore occur in the environment 100 and, even with the data flow 200, the illustrated events and their particular order in time may vary.

In the data flow 200, the AMS 106 stores ads from the advertisers 102 and receives ad decisions 202 from a particular publisher 104. The ad decisions 202 can include decisions to approve and/or disapprove certain ads and/or advertisers. These ad decisions can be based on aggregated ratings or scores, associated with ads/advertisers that are provided to the publisher 104 by the AMS 106. Such aggregated scores can represent ratings of ads/advertisers received from multiple publishers 104.

During the data flow 200, the publisher 104 may receive a content request 204 from a particular user access device 108. The content request 204 may, for example, include a request for a web document on a given topic (e.g., automobiles). In response to the content request 204, the publisher 104 may retrieve relevant content (e.g., an automobile article) from the content repository 124 or some other source.

The publisher 104 may respond to the content request 204 by sending a content page 206 or other presentation to the requesting user access device 108. The content page 206 may include the requested content 208 (e.g., the automobile article) as well as a code “snippet” 205 associated with an ad. A code “snippet” refers, for example, to a method used by one device (e.g., a server) to ask another device (e.g., a browser running on a client device) to perform actions after or while downloading information. In some examples, a code “snippet” may be implemented in JAVASCRIPT® code or may be part of HTML (Hypertext Markup Language) or other web page markup language or content.

The AMS 106 may provide the code snippet 205 to the publisher 104 and/or the user access device 108. The code snippet can originate and/or be provided from other sources. As the requesting user access device 108 loads the content page 206, the code snippet 205 causes the user access device 108 to contact the AMS 106 and receive additional code (e.g., JAVASCRIPT® or the like), which causes the content page 206 to load with an ad portion 210.

The ad portion 210 may include any element that allows information to be embedded within the content page 206. In some examples, the ad portion 210 may be implemented as an HTML element, such an I-Frame (inline frame) or other type of frame. The ad portion 210 may be hosted by the AMS 106 or the publisher 104 and may allow content (e.g., ads) from the AMS 106 or the publisher 104 to be embedded inside the content page 206. Parameters associated with the ad portion 210 (e.g., its size and shape) can be specified in the content page 206 (e.g., in HTML), so that the user access device 108 can present the content page 206 while the ad portion 210 is being loaded. Other implementations of ad portion 210 may also be used.

The ad portion 210 may send the AMS 106 formatting and content information 212. This information 212 may include information describing the manner (e.g., how, when, and/or where) in which ads can be rendered by the user access devices 108. The information 212 may also include ad attributes and parameters, such as size, shape, color, font, presentation style (e.g., audio, video, graphical, textual, etc.), etc. The information 212 may also specify a quantity of ads desired.

The formatting and content information 212 can include information associated with the requested content 208 displayed in content page 206. Such information may include a URL associated with the requested content page 206. The information 212 can include the requested content itself, a category corresponding to the requested content or the content request, part or all of the content request 204, content age, content type (e.g., text, graphics, video, audio, mixed media, etc.), geo-location information, and the like.

In response to the information 212, the AMS 106 may provide the user access device 108 with ad information 214. The ad information 214 may include one or more ads 225 for placement in the ad portion 210 of the content page 206. The ad information 214 may also include a signed or encoded specification of an ad.

The ad information 214 may include ads that are relevant to user interest. The AMS 106 may retrieve and provide relevant ads based on the information 212 received from the user access device 108. The AMS 106 may retrieve the ad information 214 from the ad repository 136 using the backend processing systems 118. The AMS 106 may retrieve relevant ads using information from a crawling module, various keywords, various statistical associations between ads and content, and/or preference information associated with the publishers.

The AMS 106 may decide whether to serve certain ads with publisher content based on the ad decision 202 received from the publisher 104. For example, the AMS 106 may identify a relevant ad from the ad repository 136 based on keywords but may decide that the ad should not be served with the publisher content (e.g., the requested automobile document) because the publisher 104 has indicated in the ad decisions 202 a disapproval of the identified ad. In some examples, these ad serving decisions may be based on rules maintained by the backend processing systems 118.

The ad portion 210 may populate with ads included in the ad information 214, such as ads 225. The ad portion 210 and the displayed ads 225 may occupy a portion of the content page 206, which may be distinct from other content (e.g., the requested content 208) in the content page 206.

When a user clicks on the displayed ad 225, an embedded code snippet may direct the user access device 108 to contact the AMS 106. During this event, the user access device 108 may receive an information parcel, such as a signed browser cookie, from the AMS 106. This information parcel can include information, such as an identifier of the selected ad 225, an identifier of the publisher 104, and the date/time the ad 225 was selected by the user. The information parcel may facilitate processing of conversion activities or other user transactions.

The user access device 108 may then be redirected to the advertiser 102 associated with the selected ad 225. The user access device 108 may send a request 216 to the associated advertiser 102 and then load a landing page 218 from the advertiser 102. The user may then perform a conversion action at the landing page 218, such as purchasing a product or service, registering, joining a mailing list, etc. A code snippet 220, which may be provided by the AMS 106, may be included within a conversion confirmation page script, such as a script within a web page presented after the purchase. The user access device 108 may execute the code snippet 220, which may then contact the AMS 106 and report conversion data 222 to the AMS 106. The conversion data 222 may include conversion types and numbers as well as information from cookies. The conversion data 222 may be maintained in the conversion data repository 126.

FIG. 2 is an example only and not intended to be restrictive. Other data flows may therefore occur in the environment 100 and, even with the data flow 200, the illustrated events and their particular order in time may vary. Further, the illustrated events may overlap and/or may exist in fewer steps. Moreover, certain events may not be present and additional and/or different events may be included.

In alternative data flows, the AMS 106 can allow advertisers to approve publishers in a manner similar to the manner in which publishers approve advertisers. In such data flows, the AMS 106 can receive publisher decisions (i.e., decisions about publishers) from one or more advertisers 102. The publisher decisions made by advertisers can include approvals and disapprovals of certain publishers. These approval/disapproval decisions can be based on aggregated scores, associated with publishers that are provided to advertisers. The aggregated scores can represent ratings of publishers received from multiple advertisers 102. When providing relevant ads to the user access devices 108, the AMS 106 may take into account these publisher approvals/disapprovals. For example, the AMS 106 may decide to not provide an otherwise relevant ad to a given publisher based on the advertiser's disapproval of that publisher. Not providing a relevant ad to a publisher can include not bidding in an auction for publisher ad space.

In alternative data flows, the publisher 104 can send an ad request to the AMS 106 prior to sending a content page to the user access device 108. The AMS 106 may respond by sending relevant ads to the publisher 104. The publisher 104 may combine the received ads with requested content in the content page and then send the content page, including the ad portion, to the user access device 108 for display to a user.

In alternative data flows, the AMS 106 may selectively recommend and provide ads to the user access devices 108 based on search terms provided by the user access devices 108. In these dataflows, the AMS 106 may provide searching services and receive search terms directly from the user access devices. The AMS 106 can also receive search terms from a dedicated searching system that receives user search requests. The AMS 106 may selectively recommend and provide ads to the user access devices based on the received search terms and ad keywords provided by the advertisers. Other modifications to the data flow 200 are also possible.

In situations in which the systems discussed herein collect personal information about users, or may make use of personal information, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

As described herein, the present disclosure addresses the valuation of advertisements that are the subject of ad auctions for placement on a publisher's online website. The valuation of an advertisement enables an advertiser, particularly an advertiser bidding for placement of Cost-per-Action (“CPA”)-based advertising, to appropriately set their bids towards maximizing revenue realized from consumers taking action following exposure to their advertisements. Existing CPA bidding products in the online advertisement industry require advertisers to provide a fixed CPA value (e.g., $5) in order for their ads to participate in online ad auctions. That is, in the foregoing example, advertisers pay a fixed $5 fee per qualifying consumer action. In the example embodiment, a qualifying consumer action is a straightforward online purchase, a consumer acquisition (such as a NETFLIX® account signup), a mobile application (“app”) download, or other activity likely to result in immediate and/or future revenue generation. However, the lifetime revenue from each consumer after that consumer is acquired can be variable. For example, a mobile user A that downloads a mobile gaming app may make more in-app purchases of virtual goods than does a mobile user B. Mobile user A therefore generates more revenue for the mobile app developer (the advertiser) than does mobile user B. However, using current CPA advertising methods, the mobile app developer pays a single flat price (e.g., $5) as the cost for acquiring both mobile app user A and mobile app user B.

CPA-based advertising is desirable to advertisers, because while the average cost to the advertiser may be higher than the costs associated with either CPM or CPC-based advertising, the risk and incidence of invalid clicks is lower, in that an advertiser is only charged when a definite sale to a consumer, or other qualifying action having a substantial likelihood of leading to a sale occurs. However, as previously stated, the cost that an advertiser pays for placement of an advertisement is fixed, while the revenue that is realized from the consumers that are acquired through qualifying actions is variable.

However, if AMS 106 can predict the lifetime revenue of the consumers for which AMS 106 bids for placement of advertisements, AMS 106 can bid more aggressively on behalf of the advertiser 102 to place advertisements to those users (consumers) 107 that offer the prospect of generating higher lifetime revenue. More aggressive bidding is anticipated to result in more successful bids to place ads with more lucrative consumers, as well as generally increasing the advertiser's consumer base.

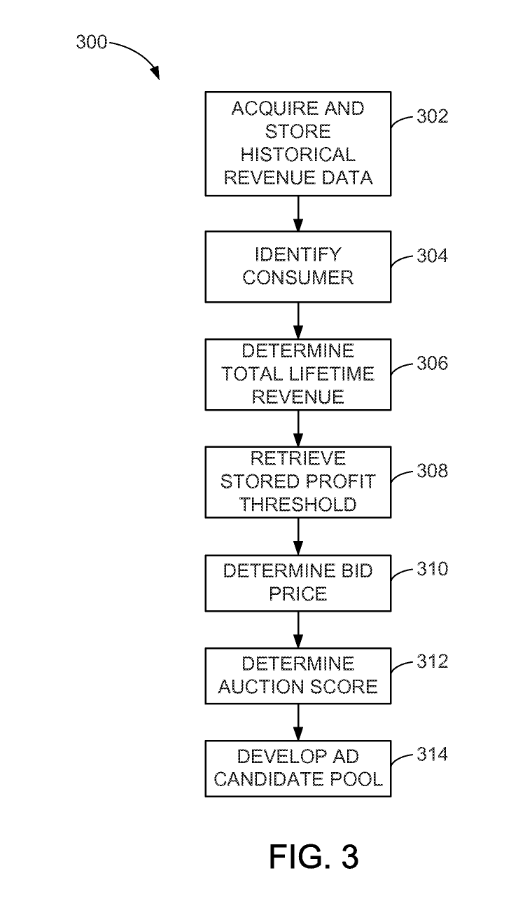

FIG. 3 is a flowchart of an example method 300 implemented using the advertising server system of FIGS. 1 and 2 for valuing an advertisement served to an online consumer. In the example embodiment, AMS 106 acquires and stores 302 in database 146 historical data regarding revenue generated by individual online users (consumers) 107 (shown in FIG. 1). During an online advertisement placement auction, AMS 106 identifies 304 a specific advertisement from an advertiser 102 to be the subject of a bid for placement with a specific item of online content from a specific publisher 104, for presentation to a specific consumer 107. AMS 106 identifies 304 the consumer 107 to whom the advertisement potentially may be placed.

AMS 106 then determines 306 the Expected Total Lifetime Revenue that specific consumer 107 may generate through interaction with the specific advertisement. As used herein, “Expected Total Lifetime Revenue” is the sum of past revenue generated by consumer 107 arising directly from interaction with the specific advertisement and/or with similar advertisements, and the predicted total future revenue generated by consumer 107. As used herein, “similar” advertisements are advertisements having one or more characteristics in common, such as product class, price, etc., as defined by advertiser 102. In the example embodiment, total future revenue from consumer 107 is calculated using any suitable technique sufficient to enable method 300 to be performed as described. For example, presuming that the specific consumer 107 in question has a past revenue history, a reasonable basis for prediction may be based on the assumption that the consumer's past spending or other activity history, with respect to the same or similar types of advertisements, is an indication of potential future revenue generating activity. Alternatively, if the specific consumer 107 does not have a past revenue history with respect to the specific advertisement or type of advertisement, AMS 106 may retrieve data regarding similarly-situated consumers having past revenue histories, and develop a prediction of future revenue generating activity from that data.

In determining 306 Expected Total Lifetime Revenue, AMS 106 applies a cutoff standard, so that revenue generated by online activity by consumer 107 may be properly attributed. In one embodiment, revenue generated as a result of online activity by consumer 107 must be directly attributable to a specific original qualifying action. For example, consumer 107 clicks on an advertisement for a mobile app, and registers for or acquires the mobile app. The act of registration or acquisition is, in itself, a qualifying act for purposes of revenue attribution. If consumer 107, while operating within the acquired app, makes a further registration, purchase or other qualifying action, any revenue generated during that subsequent qualifying action will be considered as arising from the specific original qualifying action mentioned above. That is, actions taking place within an acquired application are not considered to be revenue generators in their own right; rather, revenue from such actions is attributed to the original qualifying action. This is one example of a possible cutoff standard. In alternative embodiments, other cutoff standards may be applied, provided that the cutoff standards are applied uniformly, so as to enable the methods and systems of the present disclosure to function as described herein.

After total lifetime revenue has been determined 306, AMS 106 retrieves 308 a stored profit threshold previously defined by advertiser 102 and determines 310 the CPA Price (maximum price advertiser 102 is willing to bid). As used herein, “profit threshold” refers to a numerical value that reflects a minimum profit expectation on the part of advertiser 102. In an example embodiment, advertiser 102 is permitted to define their profit threshold in one of at least two formats. In one format, the profit threshold is defined as a Lifetime Gross Profit amount specified by advertiser 102. In another format, the profit threshold is defined as a percentage of the projected Lifetime Gross Revenue, as specified by advertiser 102. The method by which AMS 106 determines 310 the CPA Price depends upon which format of profit threshold advertiser 102 selects.

For example, if advertiser 102 selects the profit threshold to be the minimum Lifetime Gross Profit amount that advertiser 102 requires, then the CPA Price is determined as follows:

CPA Price=Expected Total Lifetime Revenue−Advertiser-Defined Lifetime Gross Profit

Assuming advertiser 102 requires a minimum Lifetime Gross Profit of $10, for a consumer 107 that generates $11 of Expected Total Lifetime Revenue, the CPA Price is $1. For a consumer 107 that generates $20 of Expected Total Lifetime Revenue, the CPA Price is $10.

However, if advertiser 102 selects the profit threshold to be a percentage of Lifetime Gross Revenue, the percentage defined by advertiser 102, then the CPA Price is determined as follows:

CPA Price=Expected Total Lifetime Revenue×(1−% of Lifetime Gross Revenue)

Assuming that advertiser 102 sets the percentage of total Lifetime Gross Revenue to be 50%, then for a consumer 107 expected to generate $11 of Expected Total Lifetime Revenue, the CPA Price is $5.5, while for a consumer 107 expected to generate $20 of Expected Total Lifetime Revenue, the CPA Price is $10.

Once CPA Prices for one or more advertisements eligible for an auction have been determined 310, AMS 106 determines 312 auction scores for each advertisement. In one embodiment, an auction score is determined as follows:

$$Auction Score = \frac{CPA Price \times Action Probability \times Click Probability}{Predicted Auction Discount}$$

where “Action Probability” is the probability that a consumer 107 will a qualifying action after having clicked on an advertisement; and “Click Probability” is the probability that a consumer 107 will “click” on an advertisement after having had the advertisement presented to them (“an impression”). “Predicted Auction Discount” is a predicted ratio between a final price or winning bid, charged for successful placement of the advertisement on a publisher's website, and the original maximum bid, representing the maximum possible amount each advertiser is willing to pay before the auction occurs. For example, in a “first price” auction (which is one in which each bidder bids the maximum that they are willing to pay without regard or possibly even knowledge of other bidders' bids and the winning bidder pays the amount of their bid), the “Predicted Auction Discount” should usually be 1.0 because the ratio between the final price and the maximum bid of each advertisement is always 1.0. In a “second price” auction (which is one in which the winning bidder only pays based on the amount of the second-highest bid), the “Predicted Auction Discount” is typically between 0 and 1.0, because the auction winner is charged based on the pricing of the runner-up in the auction, and is charged with a final price that is less than the maximum bid. Action Probability, Click Probability and Predicted Auction Discount may be calculated using any suitable known technique that is sufficient to enable the steps of method 300 to be performed as described herein.

AMS 106 generates auction scores for a predefined number of advertisements to develop 314 a pool of candidate advertisements for presentation to a publisher. Typically, the candidate advertisements are ranked according to auction score. Accordingly, because auction score is directly proportional to CPA price, the higher a price that advertiser 102 is willing to pay, the higher the auction score for the advertisement is likely to be. The methods described herein enable an advertiser 102 to value their advertisements in relation to their estimated lifetime revenues, relative to the specific consumers to whom the advertisements may be presented.

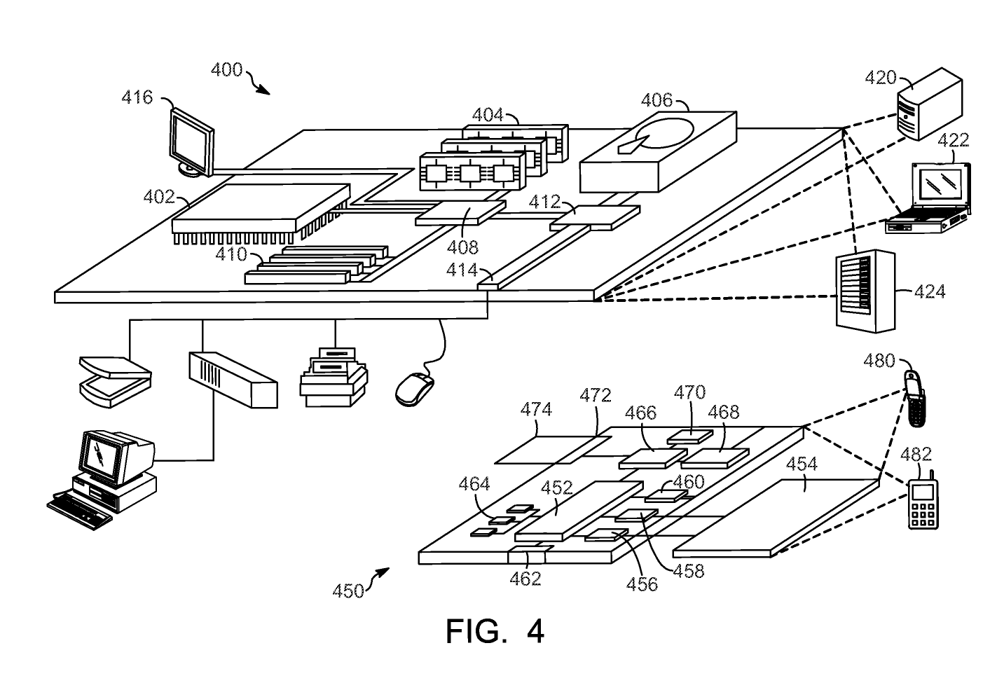

FIG. 4 is a diagram of an example computing devices/systems 400 and 450 that may be used in the environment shown in FIG. 1. More specifically, FIG. 4 shows an example of a generic computing device 400 and a generic mobile computing device 450, which may be used with the techniques described here. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smart phones, and other similar computing devices. The components shown here, their connections and relationships, and their functions, are meant to be for the purpose of example only, and are not meant to limit implementations of the disclosures described and/or claimed in this document.

Computing device 400 includes a processor 402, memory 404, a storage device 406, a high-speed interface/controller 408 connecting to memory 404 and high-speed expansion ports 410, and a low speed interface/controller 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a volatile memory unit or units. In another implementation, the memory 404 is a non-volatile memory unit or units. The memory 404 may also be another form of computer-readable medium, such as a magnetic or optical disk.

The storage device 406 is capable of providing mass storage for the computing device 400. In one implementation, the storage device 406 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of functions is for purposes of example only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed buss 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as computing device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The computing device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can execute instructions within the computing device 450, including instructions stored in the memory 464. The processor may be implemented as a chipset of chips that include separate and multiple analog and digital processors. The processor may provide, for example, for coordination of the other components of the computing device 450, such as control of user interfaces, applications run by computing device 450, and wireless communication by computing device 450.

Processor 452 may communicate with a user through control interface 458 and display interface 456 coupled to a display 454. The display 454 may be, for example, a TFT LCD (Thin-Film-Transistor Liquid Crystal Display) or an OLED (Organic Light Emitting Diode) display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of computing device 450 with other devices. External interface 462 may provide, for example, for wired communication in some implementations, or for wireless communication in other implementations, and multiple interfaces may also be used.

The memory 464 stores information within the computing device 450. The memory 464 can be implemented as one or more of a computer-readable medium or media, a volatile memory unit or units, or a non-volatile memory unit or units. Expansion memory 474 may also be provided and connected to computing device 450 through expansion interface 472, which may include, for example, a SIMM (Single In Line Memory Module) card interface. Such expansion memory 474 may provide extra storage space for computing device 450, or may also store applications or other information for computing device 450. Specifically, expansion memory 474 may include instructions to carry out or supplement the processes described above, and may include secure information also. Thus, for example, expansion memory 474 may be provide as a security module for computing device 450, and may be programmed with instructions that permit secure use of computing device 450. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452 that may be received, for example, over transceiver 468 or external interface 462.

Computing device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, Wi-Fi, or other such transceiver (not shown). In addition, GPS (Global Positioning System) receiver module 470 may provide additional navigation- and location-related wireless data to computing device 450, which may be used as appropriate by applications running on computing device 450.

Computing device 450 may also communicate audibly using audio codec 460, which may receive spoken information from a user and convert it to usable digital information. Audio codec 460 may likewise generate audible sound for a user, such as through a speaker, e.g., in a handset of computing device 450. Such sound may include sound from voice telephone calls, may include recorded sound (e.g., voice messages, music files, etc.) and may also include sound generated by applications operating on computing device 450.

The computing device 450 may be implemented in a number of different forms, as shown in the figure. For example, it may be implemented as a cellular telephone 480. It may also be implemented as part of a smart phone 482, personal digital assistant, a computer tablet, or other similar mobile device.

Thus, various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In the example embodiment, computing systems 400 and 452 are configured to receive and/or retrieve data pertaining to: historical data regarding consumers and past revenue generated by specific consumers through interaction with specific online advertisements or classes of advertisements; data regarding advertisers, advertising links or impressions corresponding to those advertisers that appear on a web page, and metrics corresponding to the appearance of those impressions on that web page, etc., from various other computing devices connected to computing devices 400 and 452 through a communication network, and store this data within at least one of memory 404, storage device 406, and memory 464. Computing systems 400 and 452 are further configured to manage and organize the data within at least one of memory 404, storage device 406, and memory 464 using the techniques described herein.

The logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement various features may have different names, formats, or protocols. Further, the system may be implemented via a combination of hardware and software, as described, or entirely in hardware elements. Also, the particular division of functionality between the various system components described herein is merely for purposes of example, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments of the disclosure may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture, according to the discussed embodiments of the disclosure. The computer-readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

1. A computer-implemented method for valuing an advertisement served to an online publisher via an advertisement management system, comprising:
storing, by a processor of the advertisement management system within a memory device, past revenue data indicative of revenue received by an advertiser from purchases of products or services attributed to a plurality of types of advertisements presented for display via a computing device to an individual user;
determining, by the advertisement management system, a predicted total future revenue for the advertiser from purchases of the products or the services attributable to presenting the plurality of types of advertisements for display via the computing device;
determining, by the advertisement management system, an expected total lifetime revenue amount associated with presenting each advertisement type of the plurality of advertisement types to the individual user based at least partially on the past revenue data and the predicted total future revenue;
storing, by the advertisement management system within the memory device, a lifetime profit threshold received from an advertiser associated with serving one of the plurality of advertisement types associated with the advertiser for presentation via the computing device to the individual user;
determining, by the advertisement management system, a price to be charged to the advertiser for serving a first advertisement type of the plurality of advertisement types for display via the computing device to the individual user, the price being a function of the determined expected total lifetime revenue amount and the lifetime profit threshold for the first advertisement type; and
selecting, by the advertisement management based on the price, the first advertisement type for display via the computing device.

2. A method in accordance with claim 1, said method comprising:
identifying a cutoff standard indicating a plurality of qualifying actions that may be used to attribute revenue to an advertisement of each advertisement type;
using the cutoff standard to identify a past total revenue amount associated with serving the first advertisement type of the plurality of advertisement types to the selected user by only including revenue generated from the plurality of qualifying actions in determining the past total revenue amount; and
determining the expected total lifetime revenue amount associated with presenting each advertisement type of the plurality of advertisement types to the individual user based at least partially on the past total revenue amount.

3. A method in accordance with claim 2, further comprising:
identifying the cutoff standard, wherein the cutoff standard indicates that the plurality of qualifying actions include actions taken within an acquired mobile application after the selected individual registers for the acquired mobile application based on a selection of a mobile application advertisement of a mobile application advertisement type;
receiving past mobile application revenue data associated with presenting the acquired mobile application to the selected individual; and
determining the past total revenue amount for mobile application advertisement type by including past mobile application revenue data based on the cutoff standard.

4. A method in accordance with claim 1, said method comprising determining, using the computer device, a plurality of auction scores associated with the service of each of the plurality of advertisement types to the individual user, wherein the magnitude of an auction score associated with an advertisement type is proportional to the expected total lifetime revenue amount associated with the advertisement type.

5. A method in accordance with claim 1, wherein determining the expected total lifetime revenue amount associated with presenting each advertisement type of the plurality of advertisement types to the individual user further comprises:
determining, for each of the plurality of advertisement types, a similar advertisement type selected from the plurality of advertisement types;
determining a second expected total lifetime revenue amount associated with presenting each similar advertisement type to the individual user based at least partially on the past revenue data; and
substituting the second expected total lifetime revenue amount associated with each similar advertisement type for the total lifetime revenue amount associated with each corresponding advertisement type.

6. A method in accordance with claim 1, said method comprising determining, using the computer device, the price charged to the advertiser as the difference between the expected total lifetime revenue amount associated with service of the first advertisement type to the individual user, and the lifetime profit threshold, wherein the lifetime profit threshold is an advertiser-specified lifetime gross profit associated with service of the first advertisement type to the individual user.

7. A method in accordance with claim 1, said method comprising determining, using the computer device, the price charged to the advertiser as the product of the expected total lifetime revenue amount associated with service of the first advertisement type to the individual user, and the lifetime profit threshold, wherein the lifetime profit threshold is an adjustment factor based on an advertiser-specified percentage of gross revenue associated with the service of the first advertisement type to the individual user.

8. A method in accordance with claim 1, said method comprising determining, using the computer device, an auction score as a function of at least one of:
a determined price associated with the first advertisement type;
a determined probability of action by the individual user following selection by the individual user of the first advertisement type for viewing;
a determined probability of selection by the individual user of the first advertisement type for viewing following an impression of the first advertisement type; and
a predicted auction discount.

9. A non-transitory computer-readable storage media having computer-executable instructions embodied thereon for valuing an advertisement served to an online publisher via an advertisement management system, wherein, when executed by at least one processor, the computer-executable instructions cause the processor to:
store, within a memory device, past revenue data indicative of revenue received by an advertiser from purchases of products or services attributed to a plurality of types of advertisements presented for display via a computing device to an individual user;
determine a predicted total future revenue for the advertiser from purchases of the products or the services attributable to presenting the plurality of types of advertisements for display via the computing device;
determine an expected total lifetime revenue amount associated with presenting each advertisement type of the plurality of advertisement types to the individual user based at least partially on the past revenue data and the predicted total future revenue;
store a lifetime profit threshold received from an advertiser associated with serving one of the plurality of advertisement types associated with the advertiser for presentation to the individual user;
determine a price to be charged to the advertiser for serving a first advertisement type of the plurality of advertisement types to the individual user, the price being a function of the determined expected total lifetime revenue amount and the lifetime profit threshold for the first advertisement type; and
select, based on the price, the first advertisement type for display via the computing device.

10. The computer-readable storage media in accordance with claim 9, wherein the computer-executable instructions cause the processor to determine a past total revenue amount associated with serving the first advertisement type of the plurality of advertisement types to the individual user.

11. The computer-readable storage media in accordance with claim 9, wherein the computer-executable instructions cause the processor to predict a future total revenue amount associated with potential future service of the first advertisement type of the plurality of advertisement types to the individual user.

12. The computer-readable storage media in accordance with claim 9, wherein the computer-executable instructions cause the processor to determine a plurality of auction scores associated with the service of each of the plurality of advertisement types to the individual user, wherein the magnitude of an auction score associated with an advertisement type is proportional to the expected total lifetime revenue amount associated with the advertisement type.

13. The computer-readable storage media in accordance with claim 9, wherein the computer-executable instructions cause the processor to select the advertisement type having the highest determined auction score.

14. The computer-readable storage media in accordance with claim 9, wherein the computer-executable instructions cause the processor to determine the price charged to the advertiser as the difference between the expected total lifetime revenue amount associated with service of the first advertisement type to the individual user, and the lifetime profit threshold, wherein the lifetime profit threshold is an advertiser-specified lifetime gross profit associated with service of the first advertisement type to the individual user.

15. The computer-readable storage media in accordance with claim 9, wherein the computer-executable instructions cause the processor to determine the price charged to the advertiser as the product of the expected total lifetime revenue amount associated with service of the first advertisement type to the individual user, and the lifetime profit threshold, wherein the lifetime profit threshold is an adjustment factor based on an advertiser-specified percentage of gross revenue associated with the service of the first advertisement type to the individual user.

16. The computer-readable storage media in accordance with claim 9, wherein the computer-executable instructions cause the processor to determine an auction score as a function of at least one of:
a determined price associated with the first advertisement type;
a determined probability of action by the individual user following selection by the individual user of the first advertisement type for viewing;
a determined probability of selection by the individual user of the first advertisement type for viewing following an impression of the first advertisement type; and
a predicted auction discount.

17. A computer system to value an advertisement served to an online publisher via an advertisement management system comprising:
a processor; and
a computer-readable storage device having encoded thereon computer-readable instructions that are executable by the processor to perform functions comprising:
storing past revenue data indicative of revenue received by an advertiser from purchases of products or services attributed to a plurality of types of advertisements presented for display via a computing device to an individual user;
determining a predicted total future revenue for the advertiser from purchases of the products or the services attributable to presenting the plurality of types of advertisements for display via the computing device;
determining an expected total lifetime revenue amount associated with presenting each advertisement type of the plurality of advertisement types to the individual user based at least partially on the past revenue data and the predicted total future revenue;
storing a lifetime profit threshold received from an advertiser associated with serving one of the plurality of advertisement types associated with the advertiser for presentation to the individual user;
determining a price to be charged to the advertiser for serving a first advertisement type of the plurality of advertisement types to the individual user, the price being a function of the determined expected total lifetime revenue amount and the lifetime profit threshold for the first advertisement type; and
selecting, based on the price, the first advertisement type for display via the computing device.

18. The computer system in accordance with claim 17, wherein the computer-executable instructions cause the processor to determine a past total revenue amount associated with serving the first advertisement type of the plurality of advertisement types to the individual user.

19. The computer system in accordance with claim 17, wherein the computer-executable instructions cause the processor to predict a future total revenue amount associated with potential future service of the first advertisement type of the plurality of advertisement types to the individual user.

20. The computer system in accordance with claim 17, wherein the computer-executable instructions cause the processor to determine a plurality of auction scores associated with the service of each of the plurality of advertisement types to the individual user, wherein the magnitude of an auction score associated with an advertisement type is proportional to the expected total lifetime revenue amount associated with the advertisement type.

21. The computer system in accordance with claim 17, wherein the computer-executable instructions cause the processor to select the advertisement type having the highest determined auction score.

22. The computer system in accordance with claim 17, wherein the computer-executable instructions cause the processor to determine the price charged to the advertiser as the difference between the expected total lifetime revenue amount associated with service of the first advertisement type to the individual user, and the lifetime profit threshold, wherein the lifetime profit threshold is an advertiser-specified lifetime gross profit associated with service of the first advertisement type to the individual user.

23. The computer system in accordance with claim 17, wherein the computer-executable instructions cause the processor to determine the price charged to the advertiser as the product of the expected total lifetime revenue amount associated with service of the first advertisement type to the individual user, and the lifetime profit threshold, wherein the lifetime profit threshold is an adjustment factor based on an advertiser-specified percentage of gross revenue associated with the service of the first advertisement type to the individual user.

24. The computer system in accordance with claim 17, wherein the computer-executable instructions cause the processor to determine an auction score as a function of at least one of:
a determined price associated with the first advertisement type;
a determined probability of action by the individual user following selection by the individual user of the first advertisement type for viewing;
a determined probability of selection by the individual user of the first advertisement type for viewing following an impression of the first advertisement type; and
a predicted auction discount.
